(19) United States
(12) Patent Application Publication
(10) Pub. No.: US 2009/0065486 A1
(43) Pub. Date: Mar. 12, 2009

(54) PLASMA TREATMENT APPARATUS, AND SUBSTRATE HEATING MECHANISM TO BE USED IN THE APPARATUS

(75) Inventor: Jun Yamashita, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 12/281,073

(22) PCT Filed: Feb. 27, 2007
(86) PCT No.: PCT/JP07/53644

§ 371 Date: Aug. 28, 2008

(30) Foreign Application Priority Data
Feb. 28, 2006 (JP) 2006-053684

(51) Int. Cl. B23K 9/00

(52) U.S. Cl. 219/121.58

(57) ABSTRACT

A plasma processing apparatus includes a chamber configured to accommodate a target substrate; a plasma generation mechanism configured to generate plasma inside the chamber; a process gas supply mechanism configured to supply a process gas into the chamber; an exhaust mechanism connected to the chamber to exhaust gas from inside the chamber; a table configured to place the target substrate thereon inside the chamber, the table including a table main body and a heating element disposed in the main body to heat the substrate; a support portion that supports the substrate table; a fixing member that fixes the support portion to the chamber; and an electrode configured to supply a power to the heating element, wherein the heating element and the electrode are made of an SiC-containing material, the electrode is fixed to the fixing member, extends through the support portion, and is connected to the heating element at a distal end, and an electrode sheath member made of a quartz-containing insulative material envelops the electrode except for the distal end, and extends through a portion of the substrate table below the heating element, the support portion, and the fixing member.

### TECHNICAL FIELD

The present invention relates to a plasma processing apparatus for performing a plasma process on a target substrate, such as a semiconductor substrate, and a substrate heating mechanism used for the plasma processing apparatus.

### BACKGROUND ART

There are plasma processing apparatuses of various plasma excitation types used for manufacturing semiconductor devices, liquid crystal display devices, and so forth. For example, in general, RF (Radio Frequency) excited plasma processing apparatuses using RF of 13.56 MHz and microwave plasma processing apparatuses using microwaves of 2.45 GHz are employed. As compared with RF excited plasma processing apparatuses, microwave plasma processing apparatuses provide higher density plasma and lower plasma ion energy, and thus are advantageous such that members inside the processing apparatuses and target substrates can be less damaged and less contaminated.

Due to such advantages, studies have been made to apply microwave plasma processing apparatuses to processes for semiconductor substrates having larger diameters and LCD glass substrates. As a microwave plasma processing apparatus of this kind, there is known an apparatus disclosed in Jpn. Pat. Appln. KOKAI Publication No. 2003-133298.

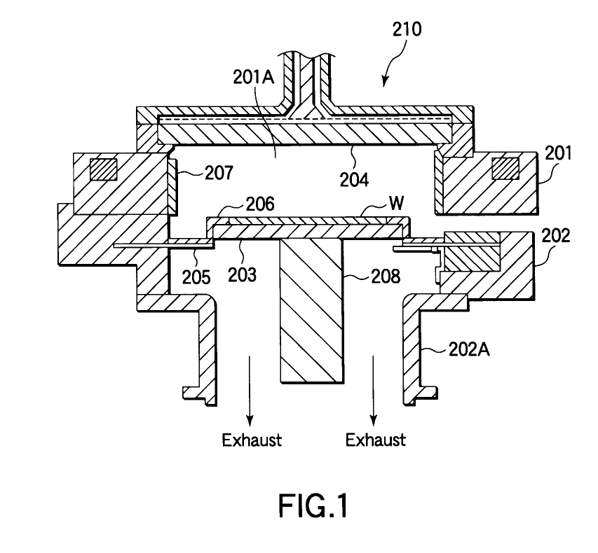

FIG. 1 is a sectional view showing a microwave plasma processing apparatus disclosed in Jpn. Pat. Appln. KOKAI Publication No. 2003-133298. This microwave plasma processing apparatus includes an upper process container 201 and a lower process container 202 that form a process space 201A. A substrate table 203 for supporting a target substrate W thereon is disposed inside the process space 201A. The upper process container 201 has an opening portion, which is sealed by a microwave transmission plate 204. A radial line slot antenna 210 is coupled with the microwave transmission plate 204. The substrate table 203 is supported by a support cylinder 208, which is surrounded by an exhaust pipe 202A connected to an exhaust mechanism (not shown) for exhausting gas from inside the process space 201A. A baffle plate 205 having a number of holes is disposed around the substrate table 203 to uniformly exhaust gas from inside the process space 201A.

The upper process container 201 is made of Al, and its inner surface is covered with an aluminum fluoride layer 207 formed by a fluoriding process. The substrate table 203 is made of Al, and its side surface and surface portion to be exposed around the target substrate W placed thereon are covered with a quartz cover 206. Accordingly, oxygen radicals generated by high density plasma are prevented from being consumed at the inner surface of the process container 201 and the exposed surface of the substrate table 203.

Where film formation is performed on a semiconductor substrate in the microwave plasma processing apparatus described above, the process temperature needs to be 700° C. or more so as to satisfy demands for good film quality and thereby to fabricate semiconductor devices with good characteristics, such as smaller leakage current. However, where the substrate table 203 includes an AlN heater, 700° C. is the upper limit of the heater in heating itself, and so the target substrate W cannot be heated to a temperature of 700° C. or more. There is a stainless steel heater that can heat to 800° C., but stainless steel heaters may cause contamination by heavy metals, such as Fe and Cr, contained in the stainless steel of the heaters. This is so, because the heavy metals are diffused inside the process container 201 due to sputtering and/or heating by plasma. Further, there is a carbon heater that can heat to a higher temperature, but carbon heaters may bring about a problem in that carbon itself causes abnormal electric discharge and thereby breaks when the substrate table 203 is exposed to microwaves. Lamp heaters cannot be used under conditions with microwaves because of the same reason.

It may be possible to use one of the heaters described above with a countermeasure for shielding microwaves, but there is no such a shielding material or shielding technique that bears a temperature of 800° C. and causes no contamination.

Accordingly, there is a great demand for a high temperature heater that stably prevents contamination where a process is performed at a high temperature while using microwave plasma or other type plasma.

### DISCLOSURE OF INVENTION

An object of the present invention is to provide a plasma processing apparatus that can stably heat a target substrate to a high temperature of 800° C. or more while preventing contamination due to particles or contaminants.

Another object of the present invention is to provide a substrate heating mechanism used for the plasma processing apparatus.

According to a first aspect of the present invention, there is provided a plasma processing apparatus comprising: a chamber configured to accommodate a target substrate; a plasma generation mechanism configured to generate plasma inside the chamber; a process gas supply mechanism configured to supply a process gas into the chamber; an exhaust mechanism connected to the chamber to exhaust gas from inside the chamber; a table configured to place the target substrate thereon inside the chamber, the table including a table main body and a heating element disposed in the main body to heat the substrate; a support portion that supports the substrate table; a fixing member that fixes the support portion to the chamber; and an electrode configured to supply a power to the heating element, wherein the heating element and the electrode are made of an SiC-containing material, the electrode is fixed to the fixing member, extends through the support portion, and is connected to the heating element at a distal end, and an electrode sheath member made of a quartz-containing insulative material envelops the electrode except for the distal end, and extends through a portion of the substrate table below the heating element, the support portion, and the fixing member.

In the first aspect, the plasma generation mechanism may include a microwave generation mechanism configured to generate microwaves, a waveguide mechanism configured to guide microwaves generated by the microwave generation mechanism toward the chamber, and an antenna having a plurality of slots configured to radiate microwaves guided by the waveguide mechanism into the chamber, so as to generate microwave plasma inside the chamber. In this case, the antenna may include a copper main body plated with gold or silver.

The plasma processing apparatus may be arranged such that at least a portion to be exposed to plasma is made of a quartz-containing material, an Si-containing material, or an SiC-containing material, or is covered with a quartz-containing liner.

The plasma processing apparatus may be arranged such that a portion to receive radiant heat from the heating element is configured to be cooled by water.

The plasma processing apparatus may be arranged such that a quartz baffle plate is disposed between the chamber and an exhaust pipe.

According to a second aspect of the present invention, there is provided a substrate heating mechanism for heating a target substrate inside a chamber of a plasma processing apparatus for performing a plasma process on the target substrate inside the chamber, the substrate heating mechanism comprising: a substrate table including a table main body and a heating element disposed in the main body to heat the substrate; a support portion that supports the substrate table; a fixing member that fixes the support portion to the chamber; and an electrode configured to supply a power to the heating element, wherein the heating element and the electrode are made of an SiC-containing material, the electrode is fixed to the fixing member, extends through the support portion, and is connected to the heating element at a distal end, and an electrode sheath member made of a quartz-containing insulative material envelops the electrode except for the distal end, and extends through a portion of the substrate table below the heating element, the support portion, and the fixing member.

In the first and second aspects, the table main body may include a base portion that supports the heating element and a cover that covers the heating element and is configured to place the target substrate thereon.

The plasma processing apparatus or the substrate heating mechanism may be arranged such that an insulating plate and a conductive plate are disposed below the fixing member; a lower end of the electrode projects from a bottom of the fixing member and extends through the insulating plate and the conductive plate, while the lower end is fixed to the fixing member by the insulating plate and the conductive plate; a seal member is interposed between the fixing member and an upper side of the conductive plate; and the conductive plate is connected to a power supply line for supplying electricity to the electrode. In this case, the conductive plate may include a first conductive plate disposed directly below the insulating plate and a second conductive plate disposed therebelow and connected to the power supply line.

The plasma processing apparatus or the substrate heating mechanism may be arranged such that the electrode sheath tube includes a larger diameter portion having a larger diameter than its other portions and extending through the fixing member from a position inside the fixing member to a bottom of the fixing member; and the fixing member includes a smaller hole and a larger hole in accordance with a shape of the electrode sheath tube to insert the electrode sheath tube therein, and the larger diameter portion sealed in the larger hole by seal members disposed on upper and lower sides.

The plasma processing apparatus or the substrate heating mechanism may be arranged such that it further comprises a thermocouple made of a SiC-containing material and a thermocouple sheath tube made of a quartz-containing material and enveloping the thermocouple; the fixing member includes a protruding portion extending downward at a lower end; and the thermocouple sheath tube envelops the thermocouple, extends through a portion of the substrate table below the heating element, the support portion, and the fixing member, and projects from the protruding portion, while a cover made of a ceramic material is fitted on a lower end of the protruding portion.

The substrate table may include a reflector made of an Si-containing material or SiC-containing material and configured to reflect heat generated by the heating element.

According to the present invention, the heating element and electrode are made of SiC, so that the temperature of the target substrate can be set at 800° C. or more, and a plasma process can be performed on the target substrate at a predetermined high temperature. Further, the substrate table 7 having a heating function has a structure that prevents contaminants from being diffused from inside when a plasma process is performed at a high temperature, so that the plasma process can be performed within a clean atmosphere. Consequently, a film with good properties can be formed. Further, the heating element can be used without damage even under microwaves, and does not cause contamination due to particles or contaminants.

The electrode for supplying a power to the heating element is enveloped by an electrode sheath tube made of a quartz-containing insulative material. Consequently, the electrode is provided with a good insulation property and is thereby prevented from causing electric discharge inside the support portion or fixing member. Further, the electrode is prevented from generating contaminants from itself.

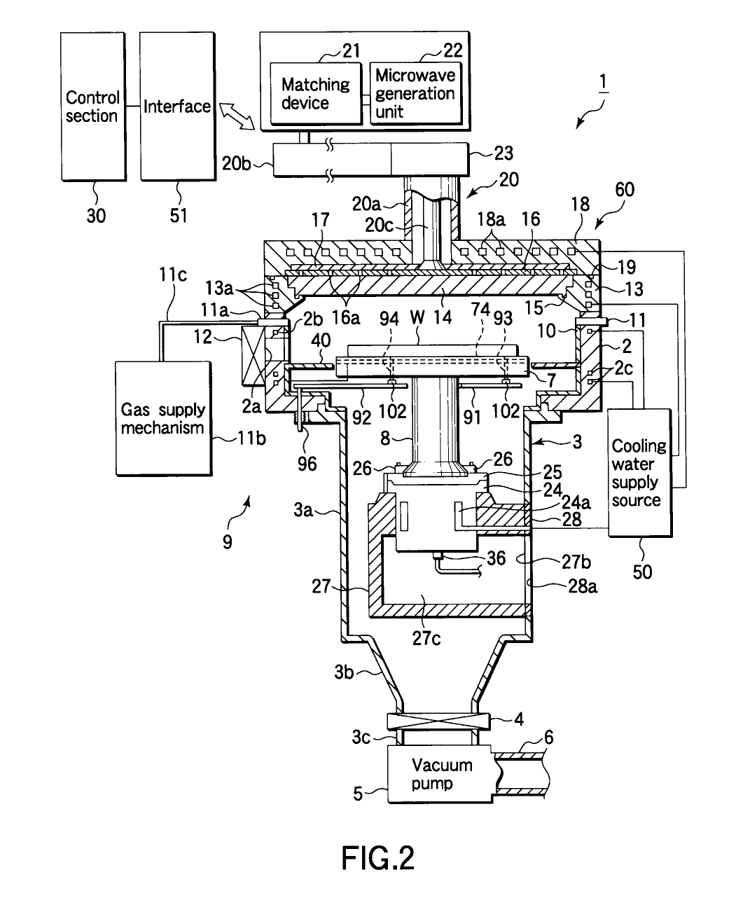

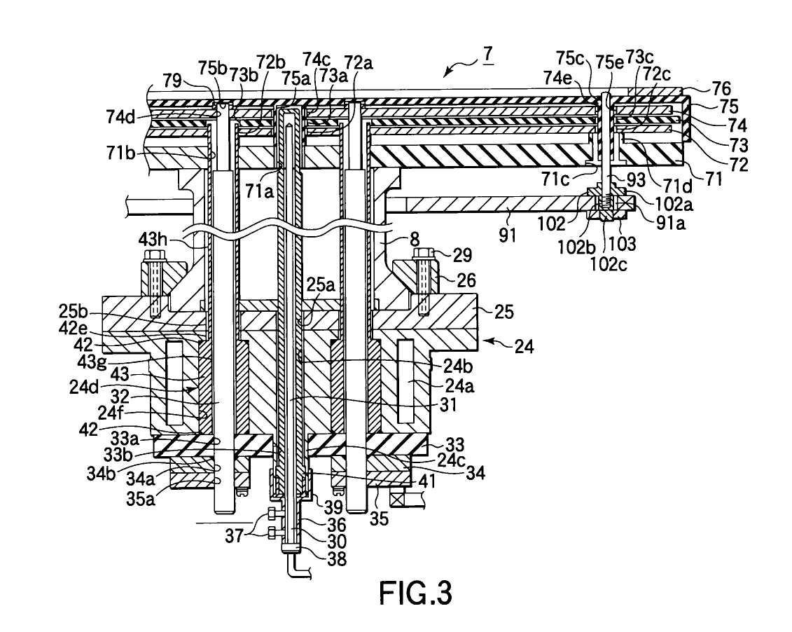

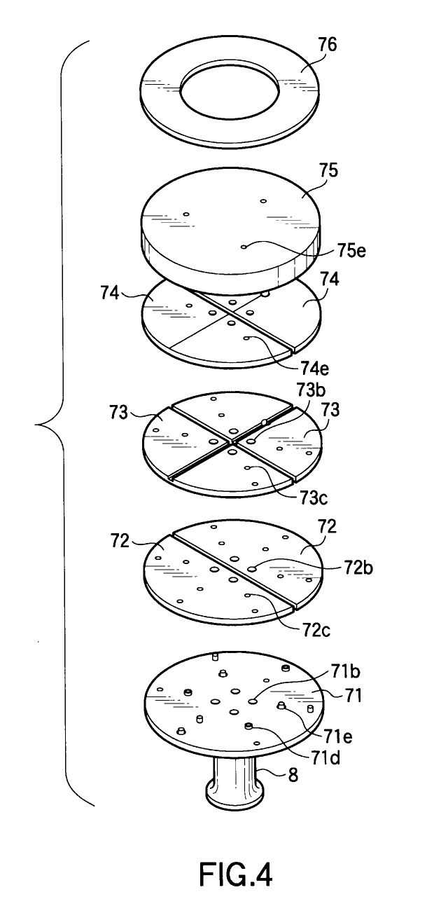

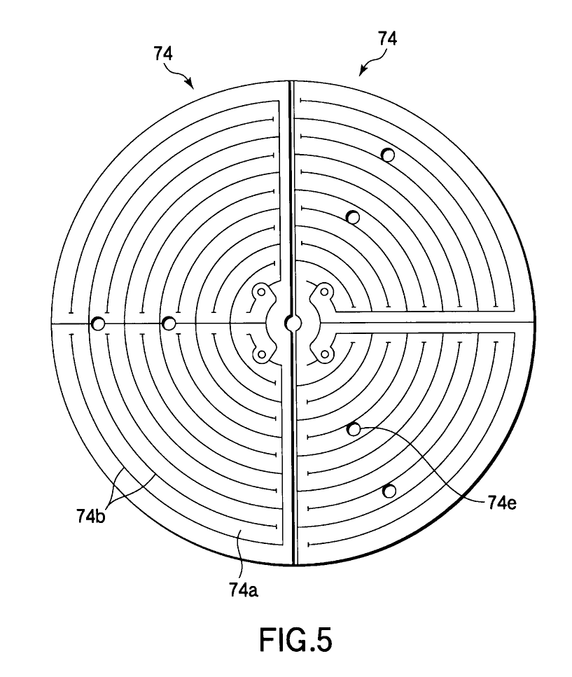

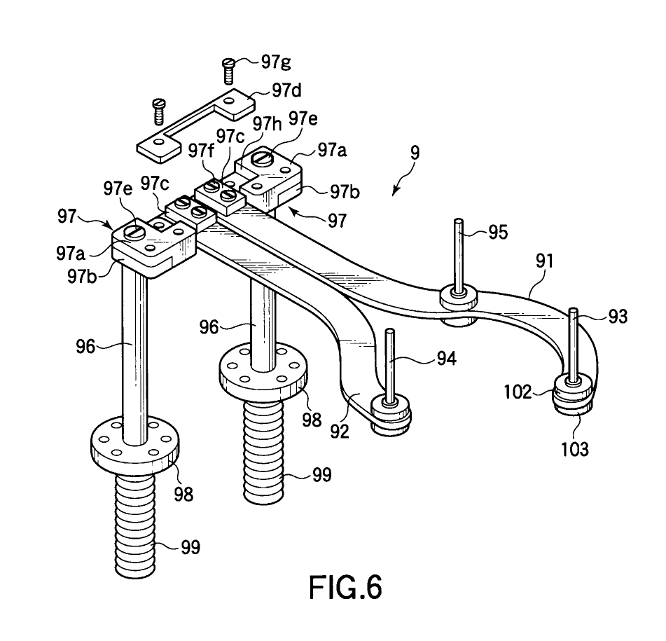

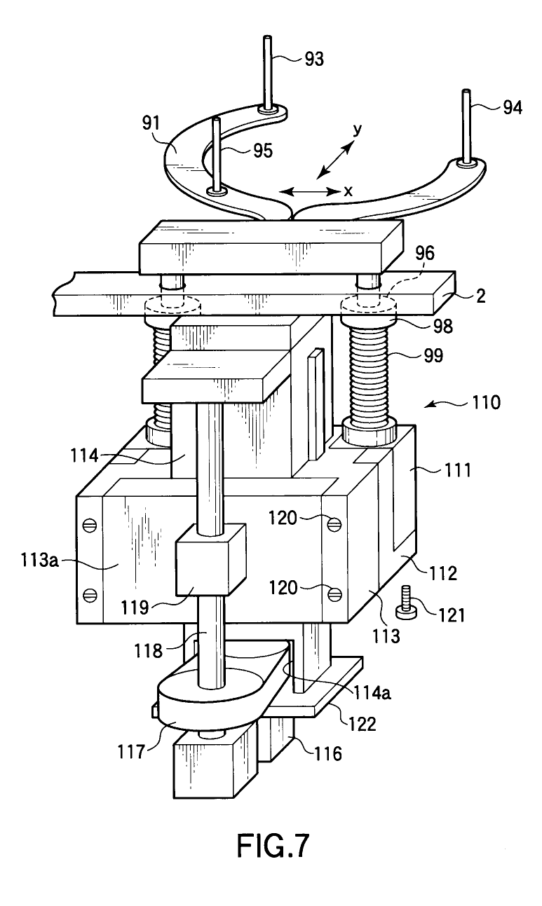

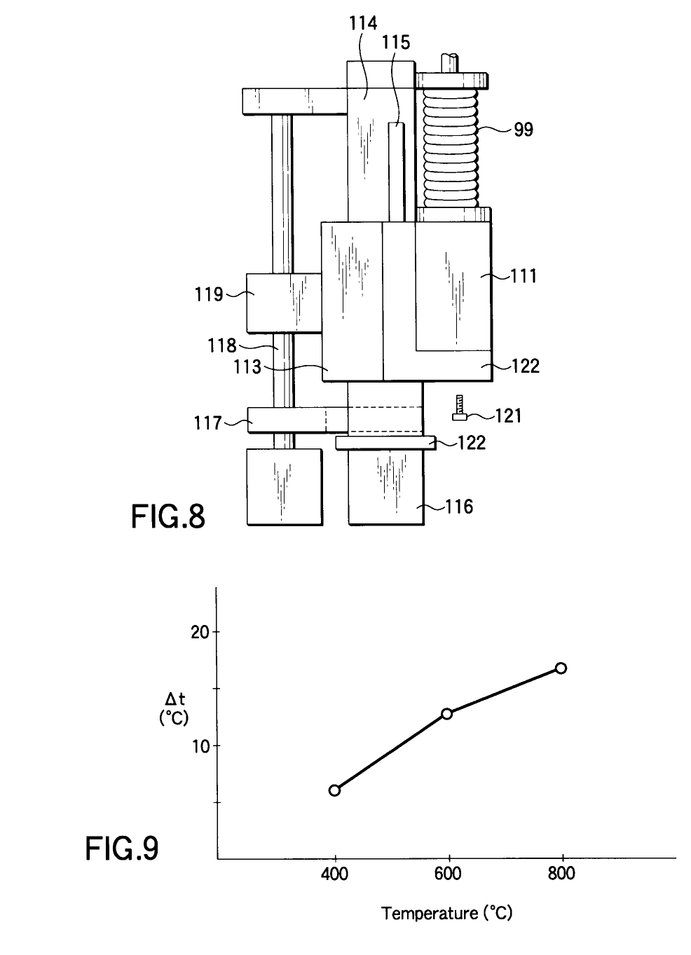

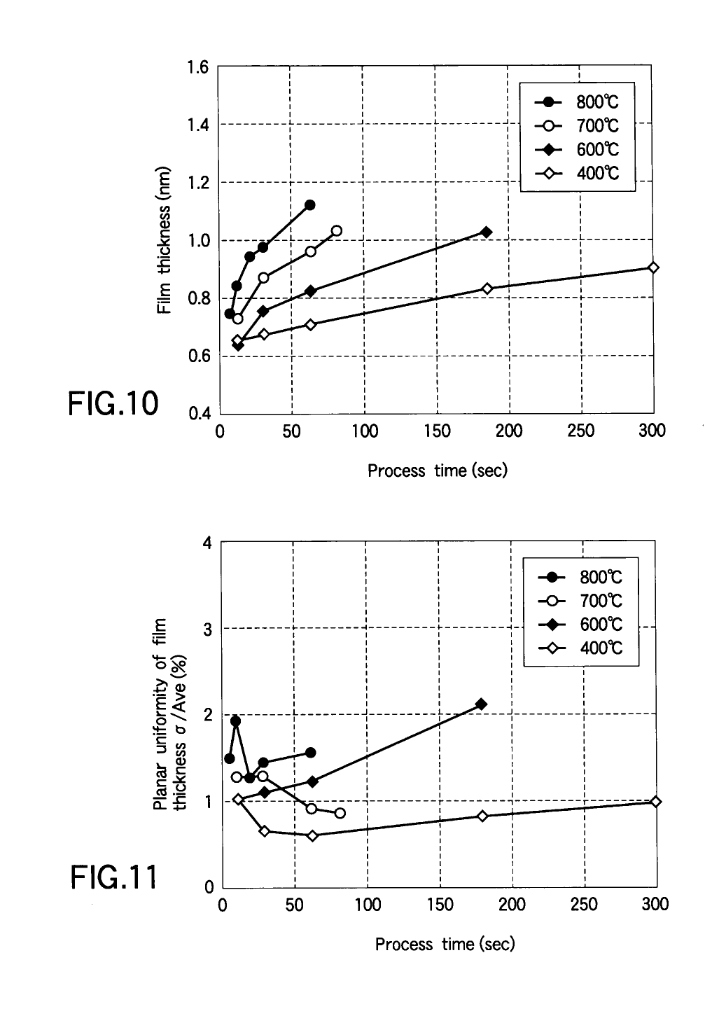

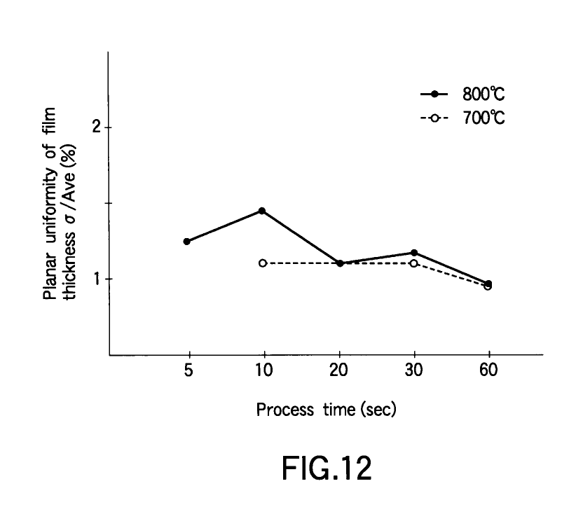

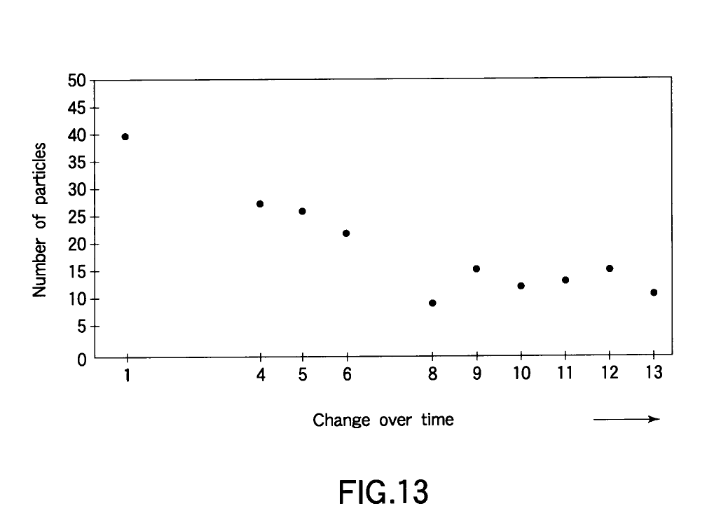

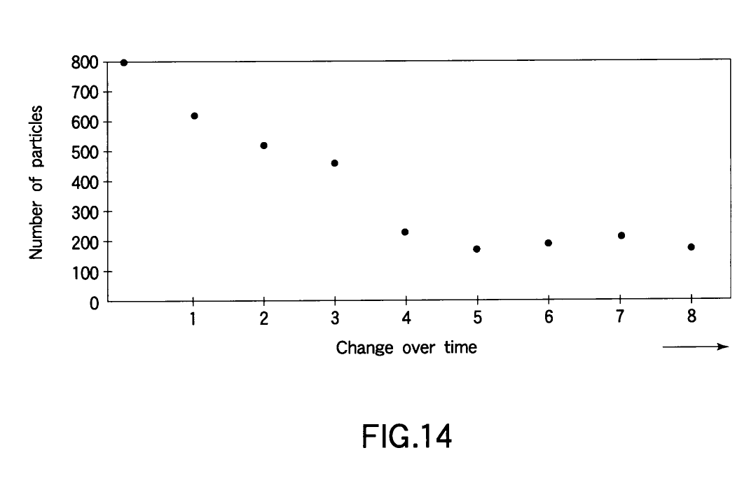

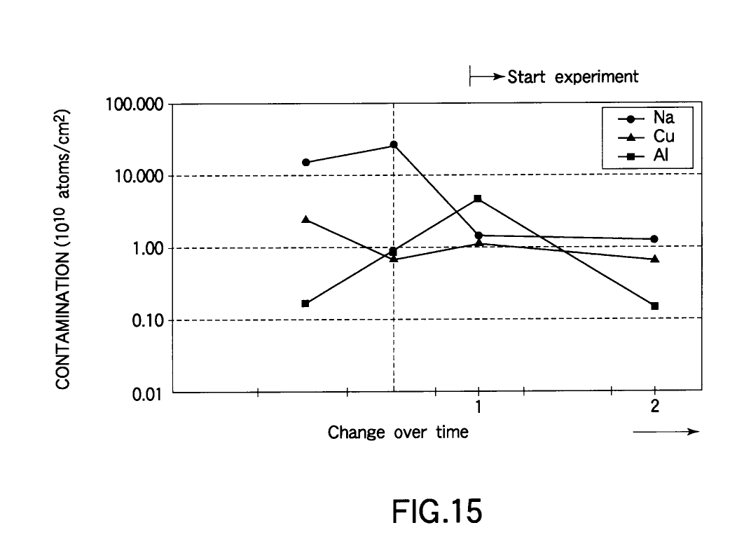

### BRIEF DESCRIPTION OF DRAWINGS

[FIG. 1] This is a sectional view showing a microwave plasma processing apparatus according to a conventional technique.

[FIG. 2] This is a sectional view schematically showing a microwave plasma processing apparatus according to an embodiment of the present invention.

[FIG. 3] This is a sectional view showing a substrate table, a support portion, and a support portion fixing member.

[FIG. 4] This is an exploded perspective view showing the substrate table and support portion.

[FIG. 5] This is a plan view showing a heating element.

[FIG. 6] This is a perspective view showing a lifter drive mechanism.

[FIG. 7] This is a back view showing the lifter drive mechanism.

[FIG. 8] This is a side view showing the lifter drive mechanism.

[FIG. 9] This is a graph showing the relationship between the process temperature and the planar thermal uniformity of a semiconductor wafer W, obtained where the semiconductor wafer was heated to different values of the process temperature in a microwave plasma processing apparatus provided with an SiC heater according to the present invention.

[FIG. 10] This is a graph showing the relationship between the process time and the thickness of an SiO₂ film, obtained where an oxidation process was performed on a semiconductor wafer to form the SiO₂ film by use of different values of the process temperature in a microwave plasma processing apparatus provided with an SiC heater according to the present invention.

[FIG. 11] This is a graph showing the relationship between the process time and the planar uniformity of an SiO₂ film on a semiconductor wafer, obtained where the SiO₂ film was formed by use of different values of the process temperature, as in the process shown in FIG. 10.

[FIG. 12] This is a graph showing the relationship between the process time and the planar uniformity of an SiO₂ film on a semiconductor wafer, obtained where the SiO₂ film was formed by use of different values of the process temperature, as in the process shown in FIG. 10.

[FIG. 13] This is a graph showing a result of an examination concerning the change over time in the presence and absence of particles on the front surface of a semiconductor wafer.

[FIG. 14] This is a graph showing a result of an examination concerning the change over time in the presence and absence of particles on the back surface of a semiconductor wafer.

[FIG. 15] This is a graph showing the change over time in generation of contaminants on a semiconductor wafer.

### BEST MODE FOR CARRYING OUT THE INVENTION

An embodiment of the present invention will now be described with reference to the accompanying drawings.

FIG. 2 is a sectional view schematically showing a microwave plasma processing apparatus according to an embodiment of the present invention. In FIG. 2, reference symbol 1 indicates a microwave plasma processing apparatus.

This microwave plasma processing apparatus 1 includes an airtight chamber 2 having an essentially cylindrical shape. The essentially cylindrical shape of the chamber 2 is made of a metal, such as Al. The bottom of the chamber 2 has an opening portion at the center, and an exhaust pipe 3 is disposed continuously to the bottom. The exhaust pipe 3 comprises an upper exhaust pipe 3a having essentially the same diameter as the opening portion, a tapered portion 3b with a diameter gradually decreasing downward, and an lower exhaust pipe 3c connected to the tapered portion 3b through a flow passage adjusting valve 4. The lower end of the lower exhaust pipe 3c is connected to a vacuum pump 5, which has a side connected to an exhaust pipe 6. When the vacuum pump 5 is operated, the atmosphere inside the chamber 2 is exhausted through the exhaust pipe 3, and the pressure inside the chamber 2 is decreased to a predetermined vacuum level.

At the center of the chamber 2, a substrate table 7 is disposed to hold a target substrate or semiconductor wafer W thereon in a horizontal state. The substrate table 7 is supported by a support portion 8 made of quartz and extending downward in the vertical direction from the center of the bottom of the substrate table 7 through the opening portion. The substrate table 7 is provided with a heating element 74 made of SiC, as described later, an electrode 32 made of SiC, and a thermocouple 31, all of which are built therein. When the heating element 74 is supplied with an electric power and thereby emits heat rays (infrared and/or far infrared rays), the semiconductor wafer W is directly heated. The structure of the substrate table 7 will be explained later in detail.

The side of the substrate table 7 is surrounded by an annular baffle plate 40 made of quartz. The quartz material of the baffle plate 40 consists preferably of high-purity quartz containing no impurity, such as synthetic quartz in this respect. More preferably, this quartz material is opaque quartz. The baffle plate 40 has a plurality of exhaust holes, and is supported by a support member. The baffle plate 40 allows gas to be uniformly exhausted from inside the chamber 2, and prevents contaminants from flowing backward from below due to microwave plasma generated inside the chamber 2.

A lifter drive mechanism 9 is arranged below the substrate table 7. The substrate table 7 has three pin insertion holes (only two of them are shown in FIG. 2) formed therethrough in the vertical direction. Pins 93 and 94 made of, e.g., quartz are inserted to be movable up and down in two of the pin insertion holes, and are supported by lifter arms 91 and 92 made of, e.g., quartz. The lifter arms 91 and 92 and pins 93 and 94 may be made of a ceramic, such as Al₂O₃ or AlN, but are preferably made of quartz in light of contamination. The lifter arms 91 and 92 are arranged to be moved up and down by elevating shafts 96, which penetrate the bottom of the chamber 2 and are movable up and down. Along with movement of the lifter arms 91 and 92, the pins 93 and 94 are moved in the vertical direction, and the semiconductor wafer W is thereby moved up and down.

The chamber 2 is provided with a liner 10 made of opaque quartz and having an essentially cylindrical shape, which is disposed along the internal surface of the chamber 2. The quartz material of the liner 10 consists preferably of high-purity quartz that can hardly cause contamination, such as synthetic quartz in this respect. The chamber 2 is opened at the top, and an annular gas feed portion 11 is attached to this opened end surface of the chamber 2. The gas feed portion 11 includes a number of gas injecting holes 11a uniformly formed on the inner side. The gas feed portion 11 is connected to a gas supply mechanism 11b through a line 11c. For example, the gas supply mechanism 11b includes an Ar gas supply source, an O₂ gas supply source, an H₂ gas supply source, an N₂ gas supply source, and other gas supply sources. Each of these gases is supplied into the gas feed portion 11, and is uniformly delivered from the gas injecting holes of the gas feed portion 11 into the chamber 2. In place of Ar gas, another rare gas, such as Kr, He, Ne, or Xe gas, may be used.

The chamber 2 has a transfer port 2a formed in the sidewall, through which the semiconductor wafer W is transferred from a transfer chamber (not shown), which is located adjacent to the microwave plasma processing apparatus 1, into the chamber 2, and from the chamber 2 into the transfer chamber. The transfer port 2a is opened and closed by a gate valve 12. A cooling water passage 2b is formed in the chamber 2 in an annular direction above the transfer port 2a and is used for cooling water to flow therethrough. Another cooling water passage 2c is formed below the transfer port 2a. Cooling water is supplied from a cooling water supply source 50 into the cooling water passages 2b and 2c.

A transmission plate support portion 13 is disposed above the chamber 2 and projects into the chamber 2. The transmission plate support portion 13 has a plurality of cooling water passages 13a formed therein in an annular direction and used for cooling water to flow therethrough. Cooling water is supplied from the cooling water supply source 50 into the cooling water passages 13a. The transmission plate support portion 13 has, e.g., two shoulder portions on the inner side, on which a microwave transmission plate 14 made of a dielectric material, such as quartz, for transmitting microwaves is airtightly fitted through a seal member 15, such as an O-ring. The dielectric material may be made of a ceramic, such as Al₂O₃ or AlN.

A circular planar antenna 16 is disposed above the microwave transmission plate 14, and is grounded through the transmission plate support portion 13. The planar antenna 16 is formed of a circular copper plate with the surface plated with gold or silver, and is formed to have, e.g., a diameter of 300 to 400 mm and a thickness of 0.1 to 10 mm (for example, 1 mm) for 200-mm wafers W. The planar antenna 16 has a number of microwave radiation holes (slots) 16a formed therethrough in the vertical direction and arrayed in a predetermined pattern. The microwave radiation holes 16a, each of which has a shape of a long slit in the plan view, are arrayed on a plurality of concentric circles and arranged such that adjacent microwave radiation holes 16a form a T-shape. The intervals of the microwave radiation holes 16a are set to be, e.g., λg/4, λg/2, or λg relative to the wavelength (λg) of microwaves. The planar antenna 16 may be rectangular.

A wave-retardation plate 17 is disposed above the planar antenna 16, and is set to have a diameter slightly smaller than the planar antenna 16. The wave-retardation plate 17 is made of, e.g., quartz or a resin, such as polytetrafluoroethylene or polyimide, which has a dielectric constant larger than that of vacuum. Since the wavelength of microwaves becomes longer in a vacuum condition, the wave-retardation plate 17 serves to shorten the wavelength of microwaves and thereby to adjust plasma, so that microwaves are efficiently transmitted.

A conductive shield member 18 is disposed above the transmission plate support portion 13 to cover the upper surface and side surface of the wave-retardation plate 17 and the side surface of the planar antenna 16. The shield member 18 cooperates with the planar antenna 16 to provide a function therebetween that serves as a waveguide tube to uniformly propagate microwaves in the horizontal direction. The portion between the transmission plate support portion 13 and shield member 18 is airtightly sealed by a ring-like seal member 19. A cooling water passage 18a is formed in the shield member 18 in an annular direction and is used for cooling water to flow therethrough. Cooling water is supplied from the cooling water supply source 50 into the cooling water passage 18a. Consequently the shield member 18, wave-retardation plate 17, planar antenna 16, and microwave transmission plate 14 are cooled, so that plasma is stably generated, and these members are prevented from being damaged or deformed. The microwave transmission plate 14, planar antenna 16, wave-retardation plate 17, and shield member 18 are integratedly attached to the transmission plate support portion 13 and constitute an openable lid 60, so that the upper side of the chamber 2 can be opened for maintenance operations.

The shield member 18 has an opening portion formed at the center, and the periphery of the opening portion is connected to a coaxial waveguide tube 20. The coaxial waveguide tube 20 is connected to a microwave generation unit 22 at one end through a matching device 21. The microwave generation unit 22 generates microwaves with a frequency of, e.g., 2.45 GHz, which are transmitted through the coaxial waveguide tube 20 to the planar antenna 16. The microwaves may have a frequency of 8.35 GHz or 1.98 GHz.

The coaxial waveguide tube 20 includes a circular waveguide tube 20a formed of an outer conductor and extending upward from the opening portion of the shield member 18, and a rectangular coaxial waveguide tube 20b connected to the upper end of the circular waveguide tube 20a through a mode transducer 23 and extending in a horizontal direction. Microwaves are propagated in a TE mode through the rectangular coaxially waveguide tube 20b, and are then turned from the TE mode into a TEM mode by the mode transducer 23. The circular waveguide tube 20a includes an inner conductor 20c at the center to constitute the coaxial waveguide tube 20 in cooperation with the circular waveguide tube 20a. The lower end of the inner conductor 20c passes through a hole formed at the center of the wave-retardation plate 17, and is connected to the planar antenna 16. Microwaves are efficiently propagated through the coaxial waveguide tube 20 to the planar antenna 16 uniformly in the radial direction.

The cylindrical support portion 8 for supporting the substrate table 7 is fixed at its bottom to a support portion fixing member 24 by a clamp 26 through a support plate 25. The support portion fixing member 24 is formed of a circular column having a flange portion. The support portion fixing member 24 is fitted in the upper portion of a fixing member mount component 27. A cooling water passage 24a is formed in an annular direction in a side of the support portion fixing member 24 and is used for cooling water to flow therethrough. Cooling water is supplied from the cooling water supply source 50 into the cooling water passage 24a, so that the support portion fixing member 24 and support plate 25 are cooled. The fixing member mount component 27 is attached to the upper exhaust pipe 3a at one side. The support portion fixing member 24, support plate 25, and fixing member mount component 27 are made of a metal material, such as Al.

The fixing member mount component 27 has an opening portion 27b on the side attached to the upper exhaust pipe 3a. The fixing member mount component 27 is fixed to the upper exhaust pipe 3a in a state where the opening portion 27b is aligned with a hole 28a formed in the upper exhaust pipe 3a. Accordingly, a space portion 27c formed in the fixing member mount component 27 communicates with the outside atmosphere through the opening portion 27b and hole 28a. The space portion 27c contains therein the wiring lines of the thermocouple 31 for measuring and controlling the temperature of the substrate table 7, and the wiring lines for supplying an electric power to the heating element 74, and so forth.

The respective components of the microwave plasma processing apparatus 1, such as the gas supply mechanism, cooling water supply mechanism, and heater temperature controller, are connected through an interface 51 to a control section 30 comprising a CPU and controlled by the control section 30. Under the control of the control section 30, a predetermined process is performed in the microwave plasma processing apparatus.

FIG. 3 is a sectional view showing the substrate table 7, support portion 8, and support portion fixing member 24. The bottom of the support portion 8 is fitted in the clamp 26 and fixed by screws 29 to the support portion fixing member 24 through the support plate 25.

FIG. 4 is an exploded perspective view showing the substrate table 7 and support portion 8. The substrate table 7 includes a base portion 71 formed of a circular plate, on which a first reflector 72 made of an Si-containing material, which is formed of a plurality of segments, such as two semicircular plates, is fitted by a plurality of protruding stoppers 71e formed on the surface of the base portion 71. On the first reflector 72, an insulating plate 73, which is formed of a plurality of segments, such as two semicircular plates, and a heating element 74, which is formed of a plurality of patterned zones, such as two semicircular zones, are fitted face to face in this order. The heating element 74 may be formed of a single zone. The upper surface of the heating element 74 and the upper side surfaces of the heating element 74, first reflector 72, and insulating plate 73 are covered with a cover 75. A wafer W can be placed on the cover 75, so that the wafer W is heated by radiant heat from the heating element 74. A ring-like second reflector 76 made of single-crystalline Si or amorphous Si is disposed on top of the cover 75.

For example, the base portion 71, insulating plate 73, and cover 75 are made of quartz. The quartz material of these members is preferably opaque quartz. The cover 75 may be also made of opaque quartz. The quartz material of these members consists preferably of high-purity quartz, such as synthetic quartz.

The heating element 74 is made of SiC having a high resistivity. This SiC may be a sintered compact or a film formed by CVD or PVD. The sintered compact may be formed by powder sintering, or by directly reacting a graphite sintered compact with an Si-containing substance, such as silicate gas. This SiC may be a crystal or amorphous, or a single-crystal formed by a suitable pull-up method.

FIG. 5 is a plan view showing the heating element 74. The heating element 74 is formed of four zones divided in the annular direction. Concentric slits 74b are formed in each of the zones, so that a serial electric current path 74a is formed such that it repeatedly bent at the border lines between zones while it extends from the central portion to the peripheral portion. The slits 74b serve to suppress thermal expansion and thermal contraction due to temperature variation. The electric current path 74a thus formed allows the semiconductor wafer W to be uniformly heated by the heating element 74.

The electric current path (pattern) is not limited to a specific shape, as long as it can perform uniform heating.

As shown in FIG. 3, the support portion fixing member 24 has a through hole 24b at the center, and the ring-like support plate 25 has a through hole 25a at the center in correspondence with the through hole 24b. The base portion 71, first reflector 72, insulating plate 73, and heating element 74 have a through hole 71a, a through hole 72a, a through hole 73a, and a through hole 74c formed therein respectively, so that a thermocouple sheath tube 41 is inserted in these through holes. The cover 75 is provided with a receiving portion 75a formed of, e.g., a protruding pipe on the bottom surface or back side reverse to the mount surface for the semiconductor wafer W. The receiving portion 75a vertically extends through the through holes 74c, 73a, and 72a to a position near the surface of the base portion 71, so that the distal end of the thermocouple sheath tube 41 can be inserted in the receiving portion 75a.

The support portion fixing member 24 has a protruding portion 24c at the center of the bottom, and the through hole 24b for inserting therein the thermocouple sheath tube 41 is formed in the support portion fixing member 24 down to the lower end of the protruding portion 24c.

The thermocouple sheath tube 41 is made of an insulative material, such as quartz, and envelops the thermocouple 31 for detecting the temperature of the table 7. The thermocouple sheath tube 41 is inserted in the through holes 24b and 25a, and extends through the space within the support portion 8 and further through the through hole 71a into the receiving portion 75a of the cover 75 at the distal end. The lower end of the protruding portion 24c is covered with a cover 36 fitted thereon and made of an insulative material, such as Al₂O₃, through a washer 39 made of a synthetic resin of a fluorocarbon resin, such as polytetrafluoroethylene. The thermocouple 31 is prevented from rotating by screws 37 that penetrate the side of the cover 36. The thermocouple 31 is connected to the outside by the lid 38 from the cover 36.

The support portion fixing member 24 has a cooling water passage 24a and a plurality of, such as four, through holes 24d formed therein around the central portion. Each of the through holes 24d is used for inserting therein an electrode sheath tube (electrode housing tube) 43 that envelops an electrode 32 having a rod-like shape for supplying a power to the heating element 24. The through hole 24d comprises an insertion hole 24e on the side facing the support plate 25 of the support portion fixing member 24 and an insertion hole 24f having a diameter larger than that of the insertion hole 24e. The support plate 25 has through holes 25b for inserting therein the electrode sheath tubes 43 at positions corresponding to the insertion holes 24e. The base portion 71, first reflector 72, and insulating plate 73 have through holes 71b, through holes 72b, and through holes 73b formed therein respectively, for inserting therein the electrode sheath tubes 43, at positions corresponding to the through holes 24b and 25b. The heating element 74 has through holes 74d, and the cover 75 has receiving holes 75b for receiving projecting parts of the electrodes 32 and stopper screws 79.

Each of the electrodes 32 is preferably made of SiC, which may be a sintered compact, single-crystal, or amorphous. The electrode 32 is enveloped in the electrode sheath tube 43 made of an insulative material, such as quartz. The electrode 32 is inserted into the support portion fixing member 24 and support plate 25, and extends through the space within the support portion 8 and further through the base portion 71 and first reflector 72. The distal end of the electrode 32 extends through the insulating plate 73 into the receiving hole 75b of the cover 75, while it is fixed to the heating element 74 by the stopper screw 79. The electrode sheath tube 43 has a stepped shape with a larger diameter portion 43g fitted in the insertion hole 24f and a smaller diameter portion 43h fitted in the insertion hole 24e and through hole 25b. O-rings (seal rings) 42 are disposed around the larger diameter portion 43g at the upper and lower ends to seal the larger diameter portion 43g. As described above, each of the electrodes 32 is enveloped by the electrode sheath tube (electrode housing tube) 43 made of an insulative material, such as quartz, from the bottom of the support portion fixing member 24 to the insulating plate 73. Further, the electrode sheath tube is sealed by the O-rings 42 to ensure airtightness, so that the electrode is prevented from generating contaminants. The electrode sheath tube 43 that envelops the electrode 32 has a good electric insulating property. The electrode sheath tube 43 has a stepped shape with the larger diameter portion 43g fitted in the insertion hole 24f and the smaller diameter portion 43h fitted in the insertion hole 24e and through hole 25b. In this case, the portion of the electrode sheath tube 43 that penetrates the fixing member 24 has a sufficient thickness and thereby provides a good electric insulating property. Further, the stepped shape allows the electrode sheath tube 43 to be stably fixed.

A fixing plate 33 made of an insulative material, such as Al₂O₃ or AlN, is disposed below the support portion fixing member 24. A first metal plate 34 and a second metal plate 35 are fixed by screws below the fixing plate 33. The fixing plate 33 has through holes 33a for inserting therein the electrodes 32 and a through hole 33b for inserting therein the protruding portion 24c. The fixing plate 33 is fixed in a state where the protruding portion 24c is fitted in the through hole 33b. The fixing plate 33 serves to electrically insulate the support portion fixing member 24 from the first metal plate 34. The first and second metal plates 34 and 35 have through holes 34a and 35a for inserting therein the electrodes 32.

The lower end of each of the electrodes 32 penetrates the through hole 33a of the insulative fixing plate 33 and the through holes 34a and 35a of the first metal plate 34 and second metal plate 35. An O-ring (seal ring) 34b is interposed between the electrode 32 and first metal plate 34 to seal this portion.

Each of the electrodes 32 is connected to the second metal plate 35, so that electricity can be supplied from a power supply source (not shown) through the second metal plate 35 to the electrode 32. This electricity is supplied from the electrode 32 to the heating element 74, so that the heating element 74 generates heat and thereby heat the semiconductor wafer W by radiant heat rays.

As described above, the first metal plate 34 serves to airtightly seal the electrode 32 by the O-ring 34b, and the second metal plate 35 serves to supply a power to the electrode. Accordingly, they are preferably made of metals suitable for their functions, such that the first metal plate 34 is made of stainless steel and the second metal plate 35 is made of an Ni alloy, for example. However, the materials of the first and second metal plates 34 and 35 are not limited to these materials, but may be selected from various materials, such that they are made of different metals or the same metal. These two metal plates may be not separated but integrated.

The base portion 71 has pin insertion holes 71c formed therethrough in the vertical direction near the edge. The base portion 71 has protruding portions 71d, which are, e.g., pipe-like, respectively connected to the rims of the upper hole portions of the pin insertion holes 71c, and the first reflector 72 is supported on top of the protruding portions 71d. Similarly, the first reflector 72, insulating plate 73, and heating element 74 have pin insertion holes 72c, pin insertion holes 73c, and pin insertion holes 74e, respectively. The cover 75 is provided with pin insertion portions 75c formed on the bottom surface and vertically extending through the pin insertion holes 74e, pin insertion holes 73c, and pin insertion holes 72c into the pin insertion holes 71c, respectively. The pin insertion portions 75c respectively have through holes 75e formed therein, in which the pins 93 are inserted to be movable up and down. The pin insertion portions 75c serve to seal contaminants inside the substrate table 7, so that contaminants are prevented from being diffused even when the substrate table 7 is heated at a high temperature, thereby realizing a heating mechanism free from contaminants.

FIG. 6 is a perspective view showing the lifter drive mechanism 9. FIG. 7 is a back view showing the lifter drive mechanism 9. FIG. 8 is a side view showing part of the lifter drive mechanism 9.

The lifter arm 91 of the lifter drive mechanism 9 has a longer length than the lifter arm 92, and is curved radially outward relative to the central axis while it extends toward the distal end. Similarly, the lifter arm 92 is curved radially outward relative to the central axis while it extends toward the distal end. The pins 93 and 95 of the lifter arm 91 and the pin 94 of the lifter arm 92 are disposed at positions separated by 120° from each other in the annular direction.

A pin support portion 102 including an upper fixing member 102a, an idler insertion portion 102b, and a screw portion 102c is fitted in a through hole 91a formed in the lifter arm 91 (see FIG. 3). The upper fixing member 102a has a larger diameter than the idler insertion portion 102b, and the pin 93 is inserted in the upper fixing member 102a while its lower end is fixedly screwed into the idler insertion portion 102b. The idler insertion portion 102b is freely inserted in the through hole 91a, and the upper fixing member 102a is set in contact with the upper surface of the lifter arm 91. The screw portion 102c has a male screw on the outer surface and projects from the through hole 91a. A lower fixing member 103 having a female screw on the inner surface is screwed on the screw portion 102c of the pin support portion 102 and is set in contact with the lower surface of the lifter arm 91.

Since the pin support portion 102 engages with the through hole 91a by a clearance fit, the pin 93 can be set in a pin hole formed in the substrate table 7 with good positional alignment. Similarly, the other pins 94 and 95 are respectively screwed in pin support portions, which engage by a clearance fit with through holes formed in the lifter arms 92 and 91, so that the pins 94 and 95 can be set in pin holes formed in the substrate table 7.

The lifter arms 91 and 92 are respectively connected to the elevating shafts 96 through coupling portions 97. The coupling portions 97 include two sets of a coupling plate 97a, a coupling plate 97b, and a stopper plate 97c, as well as a cover 97d and a plurality of screws 97e, 97f, and 97g. The lifter arms 91 and 92 are respectively fixed to the coupling plates 97a through the stopper plates 97c by the screws 97f. The coupling plates 97b are respectively connected below the ends of the coupling plates 97a. The screws 97e penetrate the coupling plates 97a and coupling plates 97b and are fixedly screwed into the elevating shafts 96, respectively.

After the two coupling plates 97a are set in position, the opposite ends of the cover 97d are fitted in recesses 97h of the coupling plates 97a. The cover 97d is fixed to the coupling plates 97a by the screws 97g while it covers the backside of the coupling plates 97a.

According to the lifter drive mechanism 9, when the cover 97d is detached and the screws 97e are loosened, the coupling plate 97a coupled with the lifter arm 91 and/or the coupling plate 97a coupled with the lifter arm 92 can be rotated relative to the elevating shafts 96, so that the lifter arms 91 and 92 are separated from each other right and left. Consequently, maintenance operations of the substrate table 7 can be easily performed.

The elevating section 110 of the lifter drive mechanism 9 includes shaft holders 111, support portions 112, a support portion 113, a column portion 114, linear slide rails 115, a motor 116, a pulley 117, a ball-screw 118, a support portion 119, and a table 122.

The shaft holders 111, support portion 112, and support portion 113 are coupled to each other. The support portion 119 is coupled to a support portion 113a fitted in the support portion 113. The linear slide rails 115 are formed on the column portion 114 to extend in the vertical direction, and engage with grooves formed in the support portion 113 to extend in the vertical direction. The column portion 114 is mounted on the table 122 above the motor 116. A recess 114a is formed in the column portion 114 on the lower side, and rotation of the motor 116 is transmitted to the pulley 117 through a mechanism disposed inside the recess 114a. Each of the elevating shafts 96 penetrates the coupling plate 98, extends through an accordion or bellows 99 made of a metal, and is connected to the corresponding shaft holder 111.

When the motor 116 is operated and the ball-screw 118 is rotated by the motor 116 through the pulley 117, the support portion 119 is thereby moved up and down. In conjunction with this, the support portion 113 and the support portions 112 and shaft holders 111 connected thereto are slid up and down along the linear slide rails 115. Consequently, the elevating shafts 96 are moved up and down, and thus the lifter arms 91 and 92 are moved up and down, while the bellows 99 ensures that the interior of the chamber 2 is airtight.

The positions of the elevating shafts 96 and lifter arms 91 and 92 coupled thereto can be fine-adjusted in a y-axis direction by rotating screws 120. Further, the positions of the elevating shafts 96 and lifter arms 91 and 92 coupled thereto can be fine-adjusted in an x-axis direction by rotating screws 121 that penetrate the bottom of the shaft holders 111 and support portions 112.

According to the microwave plasma processing apparatus 1 structure described above, for example, while Ar and O₂ are supplied from the gas feed portion 11, microwaves with a predetermined frequency are supplied from the planar antenna 16, so that high density plasma is generated inside the chamber 2. The Ar gas plasma thus excited acts on oxygen molecules to efficiently and uniformly generate oxygen radicals inside the chamber 2, by which the surface of the semiconductor wafer W placed on the substrate table 7 is oxidized. Where a nitridation process is performed on the semiconductor wafer W, a rare gas, such as Ar, and NH₃ or N₂ are supplied from the gas feed portion 11 into the chamber 2. Where O₂ gas is further supplied along with the gas used for the nitridation process, an oxynitridation process can be performed on the semiconductor wafer W. A film deposition process may be performed by use of a film deposition gas.

According to this embodiment, the heating element 74 of the substrate table 7 is made of SiC, so that the temperature of the semiconductor wafer can be set at 800° C. or more, and a heat process can be performed on the semiconductor wafer W at a sufficiently high temperature. Further, the substrate table 7 having a heating function has a structure that prevents contaminants from being diffused from inside when a plasma process is performed at a high temperature, so that the plasma process can be performed within a clean atmosphere.

Consequently, a film of high quality can be formed, so that semiconductor devices with good characteristics can be provided. Further, the substrate table 7 has an enhanced insulation property, and so plasma is prevented from being generated inside the substrate table 7, and the heating element 74 is thereby used without being damaged. Where a high purity material is used for the substrate table 7, contaminants are prevented from being diffused due to thermal diffusion when it is used at a high temperature.

According to this embodiment, the substrate table 7 includes the first reflector 72 and second reflector 76 made of a Si-containing material for reflecting heat generated by the heating element 74, so that the semiconductor wafer W is efficiently heated by heat generated by the heating element 74 and reflected by the reflectors. With this arrangement, the temperature of the semiconductor wafer W can be set at 800° C. or more by a smaller amount of heat generated by the heating element 74. Further, microwaves are also reflected and plasma is thereby excited more easily. The Si-containing material for forming the first and second reflectors 72 and 76 is exemplified by single-crystalline Si, amorphous Si, poly-silicon, and SiN. The reflectors 72 and 76 are preferably formed of a high purity product made of one of these materials.

Where a plasma process is performed at a high temperature as described above in the microwave plasma processing apparatus 1, the plasma process is realized with stable plasma generation and with very few contaminants.

FIG. 9 is a graph showing the relationship between the process temperature and the planar thermal uniformity of a 300-mm semiconductor wafer, obtained where the semiconductor wafer was heated to different values of the process temperature, 400° C., 600° C., and 800° C., in the microwave plasma processing apparatus 1 including the substrate table 7 with an SiC heater according to the present invention. In FIG. 9, the horizontal axis denotes the process temperature (° C.), and the vertical axis denotes the difference (Δt) expressed in units of “° C.” between the highest temperature and the lowest temperature on the semiconductor wafer. The pressure inside the chamber (vacuum level) was set at 126 Pa (0.95 Torr) in all the cases.

As shown in FIG. 9, where the microwave plasma processing apparatus 1 provided with an SiC heater was used, Δt was about 17° C. even at 800° C. Hence, it was confirmed that the thermal uniformity of the semiconductor wafer was within an acceptable range of Δt=20° C. or less, and good thermal uniformity was obtained even at a higher temperature.

FIG. 10 is a graph showing the relationship between the process time and the thickness of an SiO₂ film, obtained where an oxidation process was performed on a 300-mm semiconductor wafer to form the SiO₂ film by use of different values of the process temperature, 400° C., 600° C., 700° C., and 800° C., in the microwave plasma processing apparatus 1 provided with an SiC heater according to the present invention. In FIG. 10, the vertical axis denotes the film thickness (nm), the horizontal axis denotes the process time (sec).

Process conditions used at this time were an Ar gas flow rate of 2,000 mL/min (sccm), an O₂ gas flow rate of 10 mL/min (sccm), a microwave power Pu of 2,000 W, an in-chamber pressure (vacuum level) of 66.5 Pa (500 mTorr), and a base wafer of DHF-Last.

As shown in FIG. 10, with an increase in temperature, the film formation rate became higher. Particularly, the process was performed at 700° C. or more, the film formation rate grew sharply and rendered a good result. Specifically, the film formation rate obtained at 700° C. or more was 1.6 times or more of the rate obtained at 400° C. and was 1.35 times or more of the rate obtained at 600° C.

FIG. 11 is a graph showing the relationship between the process time and the planar uniformity of film thickness of an SiO₂ film on a semiconductor wafer, obtained where the SiO₂ film was formed by use of different values of the process temperature, 400° C., 600° C., 700° C., and 800° C., as in the process shown in FIG. 10. In FIG. 11, the vertical axis denotes the planar uniformity of film thickness, which is expressed in units of “%” obtained by (the largest value−the smallest value)/the average value (σ/Ave) in terms of the film thickness on the wafer. The horizontal axis denotes the process time (sec).

As shown in FIG. 11, where the microwave plasma processing apparatus 1 according to this embodiment was used, the planar uniformity of film thickness was within 2%, and rendered a good result even where the process was performed at a higher temperature. Consequently, it has been confirmed that the heater structure according to the present invention is advantageous.

FIG. 12 is a graph showing the relationship between the process time and the planar uniformity of film thickness of an SiO₂ film on a semiconductor wafer, obtained where the SiO₂ film was formed by use of different values of the process temperature, 700° C. and 800° C., as in the process shown in FIG. 10. In FIG. 12, the vertical axis denotes the planar uniformity of film thickness, which is expressed in units of “%” obtained by (the largest value−the smallest value)/the average value (σ/Ave) in terms of the film thickness on the wafer. The horizontal axis denotes the process time (sec). The film thickness was measured while the process time was set shorter as compared to the case shown in FIG. 10.

As shown in FIG. 12, where the process time was shorter than 60 sec, the planar uniformity of film thickness was within 1.5% at either of 700° C. and 800° C. Consequently, it has been confirmed that a heating mechanism having a structure according to the present invention allows a process at a high temperature to be well performed.

FIG. 13 is a graph showing a result of an examination concerning the change over time in the presence and absence of particles on the front surface of a semiconductor wafer inside a plasma process chamber. In FIG. 13, the vertical axis denotes the number of particles, and the horizontal axis denotes the change over time or the number of measurement operations of particles performed as follows.

Specifically, for the measurement operation of the number of particles, a dummy wafer was placed on the substrate table 7 inside the chamber 2, and a plasma process and an exhaust step were alternately repeated 10 times. Then, a new semiconductor wafer was placed on the substrate table, and the number of particles on the front surface of the semiconductor wafer was measured.

Process conditions used at this time were an Ar gas flow rate of 2,000 mL/min (sccm), an O₂ gas flow rate of 10 mL/min (sccm), a microwave power Pu of 2,000 W, an in-chamber pressure (vacuum level) of 66.5 Pa (500 mTorr), a process time of 60 sec, and a process temperature of 800° C.

As shown in FIG. 13, the particle generation was decreased over time. Consequently, it has been confirmed that a heating mechanism having a structure according to the present invention allows a process at a high temperature to provide a good result.

FIG. 14 is a graph showing a result of an examination concerning the change over time in the presence and absence of particles on the back surface of a semiconductor wafer. In FIG. 14, the vertical axis denotes the number of particles, and the horizontal axis denotes the change over time or the number of measurement operations of particles performed as follows. Specifically, the measurement operation of the number of particles was performed as in the case shown in FIG. 13.

As shown in FIG. 14, the particle generation was decreased over time. Consequently, it has been confirmed that a heating mechanism having a structure according to the present invention allows a process at a high temperature to provide a good result.

FIG. 15 is a graph showing the change over time in generation of metal contaminants on a semiconductor wafer. In FIG. 15, the vertical axis denotes the number of atoms of Al, Cu, and Na (10¹⁰ atoms/cm²), and the horizontal axis denotes the change over time (the number of measurement operations). The measurement operation of the number of atoms of Al, Cu, and Na was performed as in the measurement operation of particles. Specifically, a dummy wafer was placed on the substrate table 7 inside the chamber 2, and a plasma process and an exhaust step were alternately repeated 10 times. Then, a new semiconductor wafer was placed on the substrate table, and the number of atoms of Al, Cu, and Na on the front surface of the semiconductor wafer was measured.

Process conditions used at this time were an Ar gas flow rate of 2,000 mL/min (sccm), an O₂ gas flow rate of 10 mL/min (sccm), a microwave power Pu of 2,000 W, an in-chamber pressure (vacuum level) of 66.5 Pa (500 mTorr), a process time of 60 sec, and a process temperature of 800° C.

In FIG. 15, the first two operations were performed as a reference, in which a semiconductor wafer was placed on the substrate table 7 inside the chamber 2 before it was used for the process, and the number of atoms of Al, Cu, and Na was measured.

As shown in FIG. 1, the second measurement operation rendered contamination of Al, Cu, and Na close to a target value of 1×10¹⁰. The atoms of alkali metals, such as Na, and alkali earth metals can easily cause contamination due to thermal diffusion. However, the plasma processing apparatus according to the present invention maintained a clean state inside the chamber even when it was heated at a high temperature.

As described above, the microwave plasma processing apparatus 1 according to this embodiment employs the heating element 74 made of an SiC-containing material, so that the process temperature of a target substrate can be set at 800° C. or more, and the target substrate can be thereby well processed. Accordingly, semiconductor devices with good characteristics can be provided. Further, the heating element 74 is prevented from being damaged by abnormal electric discharge when it is exposed to microwaves, and is also prevented from generating contaminants due to diffusion of impurities into the chamber.

The microwave plasma processing apparatus 1 according to this embodiment is structured such that the portion to be exposed to microwaves is made of quartz, Si, or SiC of high purity, or covered with a quartz liner, and so generation of contaminants is suppressed.

If an Al member needs to be used for the portion to be exposed to microwaves, the member is preferably covered with a quartz liner or coating to isolate it from the substrate table 7. Bolts or screws, for which Al cannot provide sufficient strength, may be made of a heat-resistant Ti material of high purity.

The microwave plasma processing apparatus 1 according to this embodiment is structured such that the chamber 2, support portion fixing member 24, transmission plate support portion 13, and lid 18 can be cooled by water. In this case, since the chamber 2 and so forth are not overheated, the members are prevented from causing friction therebetween (particle generation) due to thermal expansion of the members or the portions between the members, and so generation of contaminants is suppressed.

The microwave plasma processing apparatus 1 according to this embodiment is structured such that the quartz baffle plate 40 is disposed around the substrate table 7 to intervene between the chamber 2 and exhaust pipe 3. The quartz baffle plate 40 prevents microwaves from being leaked into the exhaust pipe 3, while the baffle plate 40 does not cause contamination from itself.

The microwave plasma processing apparatus 1 according to this embodiment is structured such that the lifter arm unit is formed of a combination of two lifter arms. In this case, when the substrate table 7, support portion 8, and support portion fixing member 24 are attached, the lifter arms 91 and 92 can be separated from each other right and left to facilitate the attaching operation. The pin support portion 102 engages with the through hole 91a by a clearance fit, and the pin 93 and so forth can be shifted in the transverse direction, so that maintenance operations, such as positional alignment, can be easily performed.

In the embodiment described above, the present invention is applied to a case where a semiconductor wafer W is processed in the microwave plasma processing apparatus 1. Alternatively, the present invention may be applied to a plasma processing apparatus with another plasma source, such as a capacitively coupled type plasma source, ICP type plasma source, surface reflection type plasma source, or magnetron type plasma source. Alternatively, the present invention may be applied to a heat processing apparatus of the RTP (Rapid Thermal Process) type, CVD (Chemical Vapor Deposition) type, or PF-CVD type. Further, the present invention may be applied to manufacturing of liquid crystal display devices.

The heating element 74 is not limited to an element made of SiC, but may contain SiC as the main component. However, the heating element 74 is preferably formed of an SiC sintered compact. The heating element 74 is preferably made of high purity SiC, and more preferably made of 100%-SiC to suppress contamination or the like.

1. A plasma processing apparatus comprising:
a chamber configured to accommodate a target substrate;
a plasma generation mechanism configured to generate plasma inside the chamber;
a process gas supply mechanism configured to supply a process gas into the chamber;
an exhaust mechanism connected to the chamber to exhaust gas from inside the chamber;
a table configured to place the target substrate thereon inside the chamber, the table including a table main body and a heating element disposed in the main body to heat the substrate;
a support portion that supports the substrate table;
a fixing member that fixes the support portion to the chamber; and
an electrode configured to supply a power to the heating element,
wherein the heating element and the electrode are made of an SiC-containing material,
the electrode is fixed to the fixing member, extends through the support portion, and is connected to the heating element at a distal end, and
an electrode sheath member made of a quartz-containing insulative material envelops the electrode except for the distal end, and extends through a portion of the substrate table below the heating element, the support portion, and the fixing member.

2. The plasma processing apparatus according to claim 1, wherein the plasma generation mechanism includes a microwave generation mechanism configured to generate microwaves, a waveguide mechanism configured to guide microwaves generated by the microwave generation mechanism toward the chamber, and an antenna having a plurality of slots configured to radiate microwaves guided by the waveguide mechanism into the chamber, so as to generate microwave plasma inside the chamber.

3. The plasma processing apparatus according to claim 1, wherein the table main body includes a base portion that supports the heating element and a cover that covers the heating element and is configured to place the target substrate thereon.

4. The plasma processing apparatus according to claim 1, wherein an insulating plate and a conductive plate are disposed below the fixing member; a lower end of the electrode projects from a bottom of the fixing member and extends through the insulating plate and the conductive plate, while the lower end is fixed to the fixing member by the insulating plate and the conductive plate; a seal member is interposed between the fixing member and an upper side of the conductive plate; and the conductive plate is connected to a power supply line for supplying electricity to the electrode.

5. The plasma processing apparatus according to claim 4, wherein the conductive plate includes a first conductive plate disposed directly below the insulating plate and a second conductive plate disposed therebelow and connected to the power supply line.

6. The plasma processing apparatus according to claim 1, wherein the electrode sheath tube includes a larger diameter portion having a larger diameter than its other portions and extending through the fixing member from a position inside the fixing member to a bottom of the fixing member; and
the fixing member includes a smaller hole and a larger hole in accordance with a shape of the electrode sheath tube to insert the electrode sheath tube therein, and the larger diameter portion sealed in the larger hole by seal members disposed on upper and lower sides.

7. The plasma processing apparatus according to claim 1, wherein the apparatus further comprises a thermocouple made of a SiC-containing material and a thermocouple sheath tube made of a quartz-containing material and enveloping the thermocouple;
the fixing member includes a protruding portion extending downward at a lower end; and
the thermocouple sheath tube envelops the thermocouple, extends through a portion of the substrate table below the heating element, the support portion, and the fixing member, and projects from the protruding portion, while a cover made of a ceramic material is fitted on a lower end of the protruding portion.

8. The plasma processing apparatus according to claim 1, wherein the substrate table includes a reflector made of an Si-containing material or SiC-containing material and configured to reflect heat generated by the heating element.

9. The plasma processing apparatus according to claim 1, wherein at least a portion to be exposed to plasma is made of a quartz-containing material, an Si-containing material, or an SiC-containing material, or is covered with a quartz-containing liner.

10. The plasma processing apparatus according to claim 1, wherein a portion to receive radiant heat from the heating element is configured to be cooled by water.

11. The plasma processing apparatus according to claim 1, wherein a quartz baffle plate is disposed between the chamber and an exhaust pipe.

12. The plasma processing apparatus according to claim 2, wherein the antenna includes a copper main body plated with gold or silver.

13. A substrate heating mechanism for heating a target substrate inside a chamber of a plasma processing apparatus for performing a plasma process on the target substrate inside the chamber, the substrate heating mechanism comprising:
a substrate table including a table main body and a heating element disposed in the main body to heat the substrate;
a support portion that supports the substrate table;
a fixing member that fixes the support portion to the chamber; and
an electrode configured to supply a power to the heating element,
wherein the heating element and the electrode are made of an SiC-containing material,
the electrode is fixed to the fixing member, extends through the support portion, and is connected to the heating element at a distal end, and
an electrode sheath member made of a quartz-containing insulative material envelops the electrode except for the distal end, and extends through a portion of the substrate table below the heating element, the support portion, and the fixing member.

14. The substrate heating mechanism according to claim 13, wherein the table main body includes a base portion that supports the heating element and a cover that covers the heating element and is configured to place the target substrate thereon.

15. The substrate heating mechanism according to claim 13, wherein an insulating plate and a conductive plate are disposed below the fixing member; a lower end of the electrode projects from a bottom of the fixing member and extends through the insulating plate and the conductive plate, while the lower end is fixed to the fixing member by the insulating plate and the conductive plate; a seal member is interposed between the fixing member and an upper side of the conductive plate; and the conductive plate is connected to a power supply line for supplying electricity to the electrode.

16. The substrate heating mechanism according to claim 15, wherein the conductive plate includes a first conductive plate disposed directly below the insulating plate and a second conductive plate disposed therebelow and connected to the power supply line.

17. The substrate heating mechanism according to claim 13, wherein the electrode sheath tube includes a larger diameter portion having a larger diameter than its other portions and extending through the fixing member from a position inside the fixing member to a bottom of the fixing member; and
the fixing member includes a smaller hole and a larger hole in accordance with a shape of the electrode sheath tube to insert the electrode sheath tube therein, and the larger diameter portion sealed in the larger hole by seal members disposed on upper and lower sides.

18. The substrate heating mechanism according to claim 13, wherein the apparatus further comprises a thermocouple made of a SiC-containing material and a thermocouple sheath tube made of a quartz-containing material and enveloping the thermocouple;
the fixing member includes a protruding portion extending downward at a lower end; and
the thermocouple sheath tube envelops the thermocouple, extends through a portion of the substrate table below the heating element, the support portion, and the fixing member, and projects from the protruding portion, while a cover made of a ceramic material is fitted on a lower end of the protruding portion.

19. The substrate heating mechanism according to claim 13, wherein the substrate table includes a reflector made of an Si-containing material or SiC-containing material and configured to reflect heat generated by the heating element.
